(19) United States
(12) Patent Application Publication
(10) Pub. No.: US 2012/0079765 A1
(43) Pub. Date: Apr. 5, 2012

(54) HYDROPONIC GROWING SYSTEM WITH INCREASED ACCESSIBILITY

(76) Inventor: Richard Bell, Oxnard, CA (US)

(21) Appl. No.: 13/253,556

(22) Filed: Oct. 5, 2011

Related U.S. Application Data
(60) Provisional application No. 61/389,989, filed on Oct. 5, 2010.

(51) Int. Cl. A01G 31/06

(52) U.S. Cl. 47/60

(57) ABSTRACT

Described is a hydroponic growing system with increased accessibility. The hydroponic growing system comprises a chamber having support posts extending vertically from the top of the chamber to the bottom of the chamber, such that the support posts are attached with the top of the chamber and the bottom of the chamber. A plurality of racks having two ends is mounted perpendicular to the support posts. The plurality of racks extend toward the two sides of the chamber without contacting the two sides of the chamber, such that a space exists between each end of each rack and each side of the chamber. The space allows a user to easily access components of the hydroponic growing system for cleaning and repairs. The hydroponic growing system also comprises a plurality of irrigation pipes and a plurality of removable trays for growing plants.

### PRIORITY CLAIM

This is a Non-Provisional patent application of U.S. Provisional Application No. 61/389,989, filed Oct. 5, 2010, entitled “Hydroponic Growing System with Increased Accessibility”.

### BACKGROUND OF THE INVENTION

(1) Field of Invention

The present invention relates to a hydroponic growing system and, more particularly, to a hydroponic growing system with increased accessibility.

(1) Description of Related Art

Hydroponics is a method of growing plants using mineral nutrient solutions in water, without soil. Some hydroponic growing systems are arranged as a series of racks designed to hold growing trays to produce the desired plants. While these systems are effective in growing plants, their structural design limits accessibility and serviceability to the interior of the system due to racks which extend wall-to-wall. This is a problem for growers, since the hydroponic growing systems tend to accumulate bacteria and fungus (e.g., mold) due to the humidity and temperature within the growing systems if they are not cleaned regularly. Current designs of hydroponic growing systems prohibit easy accessibility to the interior of the system for cleaning and/or servicing of any components that fail.

Additionally, existing hydroponic systems include standard water pumps which are not rated for all-weather conditions and are positioned outside of the water tank. These water pumps, while waterproof, are not resistant to the high humidity of hydroponic systems and routinely fail.

Thus, a continuing need exists for a hydroponic growing system which provides greater accessibility and serviceability to the interior of the system. Furthermore, a need exists for a water pump which is resistant to the conditions of a hydroponic growing system to provide a longer life to the water pump.

### SUMMARY OF INVENTION

The present invention relates to a hydroponic growing system with increased accessibility. The hydroponic growing system includes a chamber comprising at least a top, a bottom, and two sides. Support posts extend vertically from the top of the chamber to the bottom of the chamber, such that the support posts are attached with the top of the chamber and the bottom of the chamber. A plurality of racks having two ends is mounted to the support posts, wherein the plurality of racks is mounted perpendicular to the support posts. The plurality of racks extend toward the two sides of the chamber without contacting the two sides of the chamber, such that a space exists between each end of each rack and each side of the chamber. The system also comprises a plurality of irrigation pipes and a plurality of removable trays for growing plants.

In another aspect, the plurality of irrigation pipes is connected with the plurality of racks.

In another aspect, the plurality of irrigation pipes is positioned at the ends of the plurality of racks.

In another aspect, the invention further comprises a fully submersible water pump and a water tank, wherein the fully submersible water pump is positioned within the water tank.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 illustrates a prior art hydroponic growing system;

FIG. 2 illustrates a hydroponic growing system with increased accessibility according to the present invention; and

FIG. 3 illustrates a fully submersible water pump within a water tank according to the present invention.

### DETAILED DESCRIPTION

The present invention relates to a hydroponic growing system and, more particularly, to a hydroponic growing system with increased accessibility. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Please note, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object.

(1) Specific Details

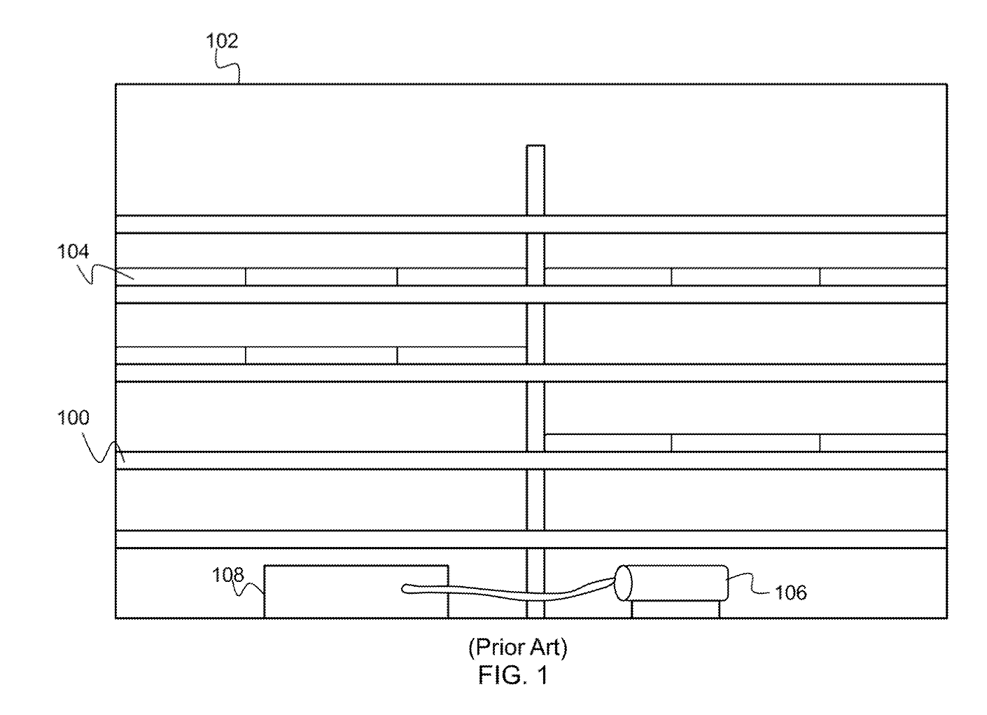

The present invention relates to a hydroponic growing system with increased accessibility and serviceability. FIG. I illustrates a prior art hydroponic growing system. As shown, the system includes a series of aligned racks 100, which extend wall-to-wall (i.e., side walls) in a chamber 102. The racks support trays 104, which hold growing plants in the hydroponic growing system. With existing systems such as the one depicted in FIG. 1, it is extremely difficult to access and service the interior of the system, which may include components such as irrigation pipes. Even if the trays 104 are removed, the design hinders a user from being able to repair a broken irrigation pipe or clean the racks 100 or other portions of the system. Since bacteria and mold can accumulate in hydroponic growing systems due to the high humidity conditions, the lack of accessibility to portions of the hydroponic growing system is a serious problem.

Additionally, FIG. 1 shows a standard water pump 106 mounted external to a water tank 108. While existing water pumps 106 are generally water-resistant, the high humidity conditions of the hydroponic growing systems often cause the water pumps 106 to fail.

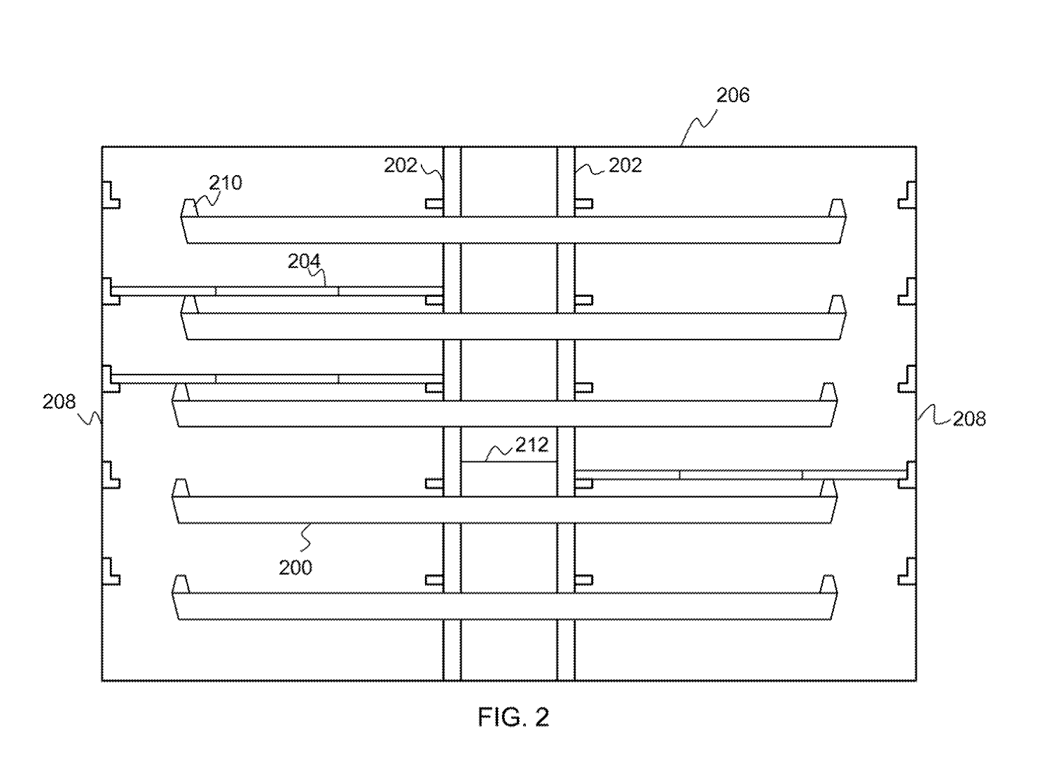

FIG. 2 illustrates a hydroponic growing system with increased accessibility according to the present invention. The key difference between existing systems and the system described herein is the accessibility and serviceability of the interior of the system. As shown in FIG. 2, the system comprises a series of aligned racks 200 which extend from a pair of center support posts 202. The racks 200 aid in supporting trays 204 for growing plants.

The center support posts 202 are supported at the top of a chamber 206 and anchored at the bottom of the chamber 206. In order to increase accessibility to the interior of the unit, the racks 200 do not extend wall-to-wall (i.e., side walls 208) in the chamber 206 such that there is open space between the side walls 208 of the chamber 206 and the racks 200. Therefore, if a user were to need to get in to clean and/or service the inner components (e.g., water pump, irrigation pipes, trays 204) of the system, one would need only to remove one or more trays 204 from the racks 200 and walk through the chamber 206 between the side walls 208 and the racks 200.

Furthermore, the present invention comprises irrigation pipes 210 positioned at the end of the racks 200. Thus, if a sprinkler pipe were to get clogged, for instance, one would need only to remove the trays 204 near the sprinkler pipe and walk along the chamber 206 between one of the side walls 208 and the racks 200 to repair it. As can be appreciated by one skilled in the art, the position of the irrigation pipes 210 at the end of the racks 200 illustrated in FIG. 2 is provided only as a non-limiting example. The irrigation pipes 210 could be placed anywhere in the system described herein, and the structural design of the present invention would increase accessibility and serviceability compared to existing systems. The present invention further comprises a fully submersible water pump (not shown) which is positioned within a water tank 210. As shown in FIG. 2, the water tank 210 may be positioned at the center of the hydroponic growing system without any accessibility problems.

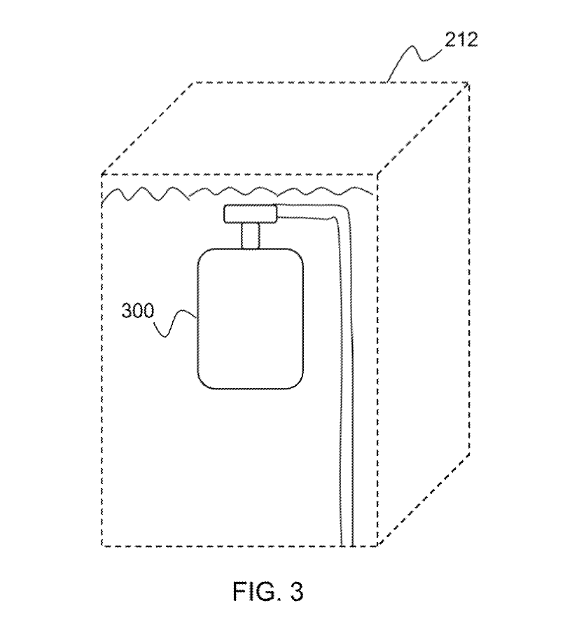

FIG. 3 illustrates a fully submersible water pump 300 positioned within the water tank 212. As described above, existing water pumps are not rated for all-weather, which means when they are mounted in hydroponic growing systems with high humidity conditions, they tend to fail. In the present invention, the water pump 300 is fully submersible within the water tank 212 to help the water pump 300 last longer and to protect it.

What is claimed is:

1. A hydroponic growing system, comprising:
a chamber comprising at least a top, a bottom, and two sides;
support posts extending vertically from the top of the chamber to the bottom of the chamber, such that the support posts are attached with the top of the chamber and the bottom of the chamber;
a plurality of racks having two ends, wherein the plurality of racks is mounted to the support posts, and wherein the plurality of racks are mounted perpendicular to the support posts;
wherein the plurality of racks extend toward the two sides of the chamber without contacting the two sides of the chamber, such that a space exists between each end of each rack and each side of the chamber;
a plurality of irrigation pipes; and
a plurality of removable trays for growing plants.

2. The hydroponic growing system as set forth in claim 1, wherein the plurality of irrigation pipes is connected with the plurality of racks.

3. The hydroponic growing system as set forth in claim 2, wherein the plurality of irrigation pipes is positioned at the ends of the plurality of racks.

4. The hydroponic growing system as set forth in claim 2, further comprising a fully submersible water pump and a water tank connected, wherein the fully submersible water pump is positioned within the water tank.
